(19) United States
(12) Patent Application Publication
(10) Pub. No.: US 2016/0051951 A1
(43) Pub. Date: Feb. 25, 2016

(54) Mixing Bucket Holder Device

(71) Applicants: Jesus Gorra, Grayson, GA (US); Vilma Morell, Grayson, GA (US)

(72) Inventors: Jesus Gorra, Grayson, GA (US); Vilma Morell, Grayson, GA (US)

(21) Appl. No.: 14/464,411

(22) Filed: Aug. 20, 2014

(51) Int. Cl. B01F 15/00; B28C 5/10

(52) U.S. Cl. CPC B01F 15/00772; B28C 5/10

(57) ABSTRACT

A mixing bucket holder device holds a mixing bucket stationary while contents of the mixing bucket are being mixed. The device includes a support having a top wall, a bottom wall and a perimeter wall coupled to and extending between the top wall and the bottom wall. The top wall has a depression therein for receiving a mixing bucket. The depression has a lower wall and a peripheral wall coupled to and extending upwardly from the lower wall. The perimeter wall of the support has at least one opening extending therein for receiving feet of a user. A plurality of wheels is coupled to the bottom wall. A retaining assembly is coupled to the depression. The retaining assembly engages the mixing bucket and maintains the mixing bucket in a stationary position while contents of the mixing bucket are mixed together.

### BACKGROUND OF THE DISCLOSURE

### Field of the Disclosure

The disclosure relates to holding devices and more particularly pertains to a new holding device for holding a mixing bucket stationary while contents of the mixing bucket are being mixed.

### SUMMARY OF THE DISCLOSURE

An embodiment of the disclosure meets the needs presented above by generally comprising a support having a top wall, a bottom wall and a perimeter wall coupled to and extending between the top wall and the bottom wall. The top wall has a depression therein configured for receiving a mixing bucket. The depression has a lower wall and a peripheral wall coupled to and extending upwardly from the lower wall. The perimeter wall of the support has at least one opening extending therein for receiving feet of a user. A plurality of wheels is coupled to the bottom wall. A retaining assembly is coupled to the depression. The retaining assembly is configured to engage the mixing bucket and maintain the mixing bucket in a stationary position while contents of the mixing bucket are mixed together.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a mixing bucket holder device according to an embodiment of the disclosure.

FIG. 2 is a front view of an embodiment of the disclosure.

FIG. 3 is a bottom view of an embodiment of the disclosure.

FIG. 4 is a cross-sectional view of an embodiment of the disclosure taken along line 4-4 of FIG. 2.

FIG. 5 is an in-use side view of an embodiment of the disclosure.

### DESCRIPTION OF THE PREFERRED EMBODIMENT

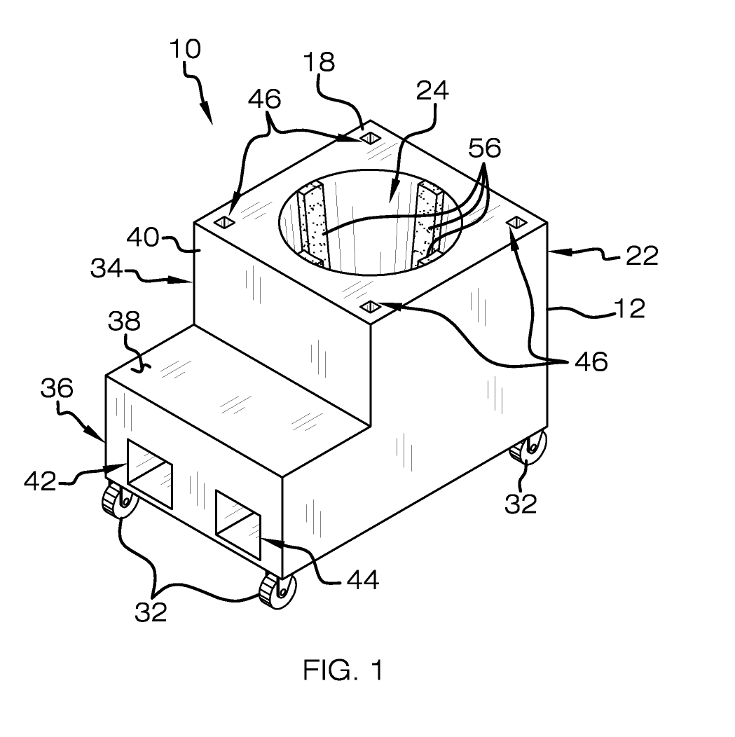

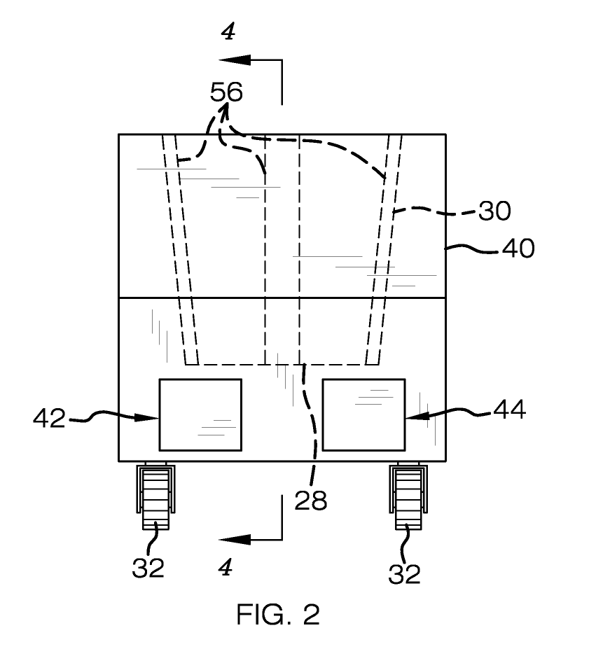

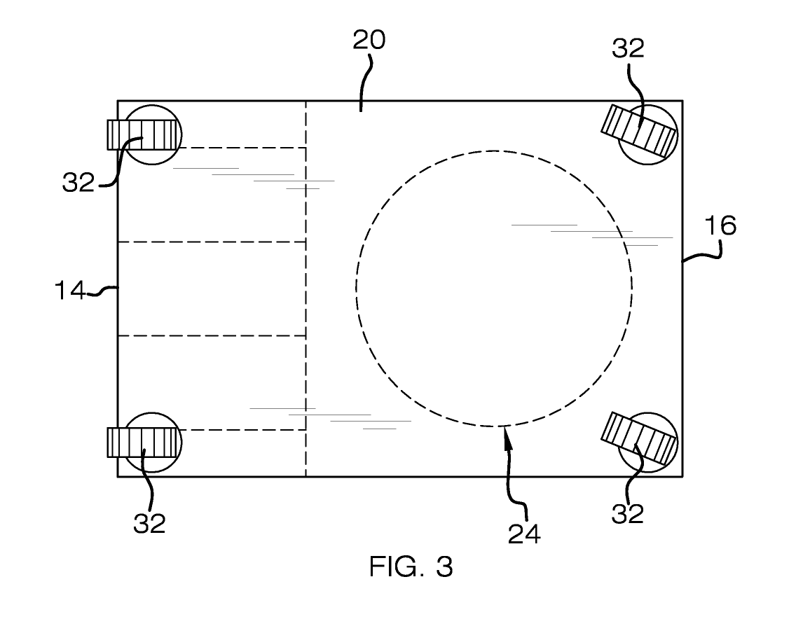

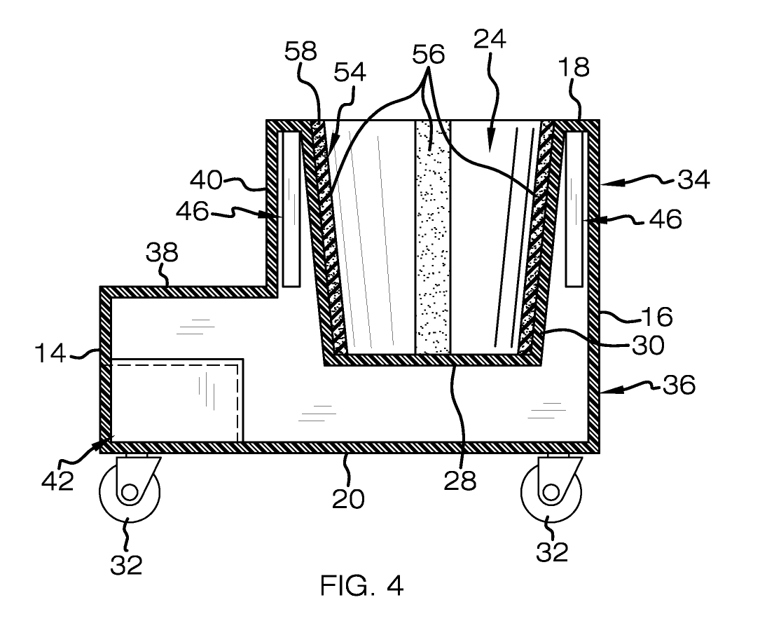

With reference now to the drawings, and in particular to FIGS. 1 through 5 thereof, a new holding device embodying the principles and concepts of an embodiment of the disclosure and generally designated by the reference numeral 10 will be described.

As best illustrated in FIGS. 1 through 5, the mixing bucket holder device 10 generally comprises a support 12 having a top wall 18, a bottom wall 20 and a perimeter wall 22. The perimeter wall 22 is coupled to and extends between the top wall 18 and the bottom wall 20. The support 12 has the perimeter wall 22 including a first end 14 and a second end 16. The top wall 18 has a depression 24 therein configured for receiving a mixing bucket 26, which may be conventional and of the type commonly used in the construction industry for mixing drywall, paint or like material. The depression 24 may be positioned proximate the second end 16 and comprises a lower wall 28 and a peripheral wall 30 coupled to and extending upwardly from the lower wall 28. The lower wall 28 is planar and horizontally orientated. The peripheral wall 30 may taper inwardly from the top wall 18 to the lower wall 28. A plurality of wheels 32, which may comprise swivelable casters, is coupled to the bottom wall 20 of the support 12 to facilitate transportation of the device 10 on a supporting surface.

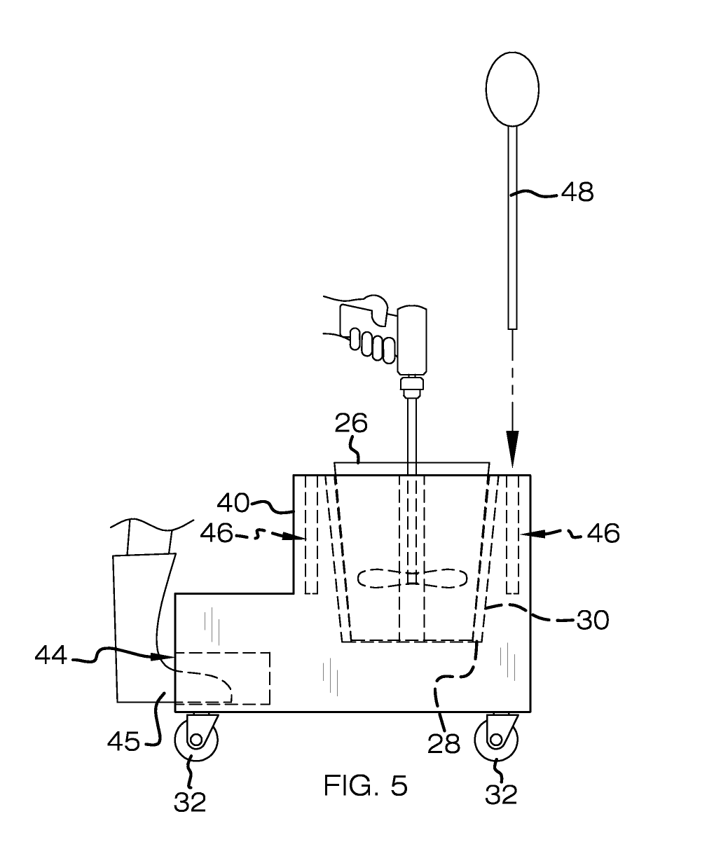

The support 12 may include an upper section 34 and a lower section 36 integrally coupled together. The upper section 34 includes the top wall 18. The lower section 36 has a top surface 38 spaced below the top wall 18. The perimeter wall 22 of the support 12 includes a medial wall 40 coupled to and extending between the top wall 18 and the top surface 38 of the lower section 36. The perimeter wall 22 of the support 12 has at least one opening 42, 44 extending therein. The openings 42, 44 extend into the lower section 36 of the support 12, and more particularly, may extend into the first end 14 of the support 12. The openings 42, 44 are spaced and horizontally aligned relative to each other wherein each of the openings 42, 44 is configured for receiving a foot 45 of a user therein. The top wall 18 has a plurality of compartments 46 extending therein each configured for receiving a stifling device 48, such as the one shown in FIG. 5. Each compartment 46 has a vertically-oriented longitudinal axis.

A retaining assembly 54 is positioned on and attached to the peripheral wall 30 of the depression 24 and is configured to engage the mixing bucket 26 and maintain the mixing bucket 26 in a stationary position while contents of the mixing bucket 26 are mixed together. The retaining assembly 54 may include a plurality of securing members 56 spaced from each other on the peripheral wall 30 of the depression 24. Alternatively, the retaining assembly 54 may include a single continuous securing member 56 that extends around a circumference of the peripheral wall 30. Each of the securing members 56 is comprised of a non-slip material 58, such as sandpaper, elastomers or the like. Each of the securing members 56 may be elongated and may extend from the top wall 18 of the support 12 to the lower wall 28 of the depression 24.

In use, the mixing bucket 26 is placed into the depression 24 and contents to be mixed are poured into the mixing bucket 26. The user's feet 45 are then inserted into the openings 42, 44. A stifling device 48, which may be manual or electric, is inserted into the mixing bucket 26 to mix the contents of the mixing bucket 26 in a conventional manner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A mixing bucket holder device comprising:
a support having a top wall, a bottom wall and a perimeter wall coupled to and extending between said top wall and said bottom wall, said top wall having a depression therein configured for receiving a mixing bucket, said depression comprising a lower wall and a peripheral wall coupled to and extending upwardly from said lower wall, said perimeter wall of said support having at least one opening extending therein configured for receiving feet of a user, said opening being directed inwardly into said support and towards said depression, said opening having a depth extending into said support such that an entirety of said opening is offset from said depression, a top of said opening being coplanar with said lower wall;
a plurality of wheels coupled to said bottom wall of said support; and
a retaining assembly positioned in and attached to said depression, said retaining assembly being configured to engage the mixing bucket and maintain the mixing bucket in a stationary position while contents of the mixing bucket are being mixed together.

2. The device of claim 1, further comprising said lower wall of said depression being planar and horizontally orientated.

3. The device of claim 1, further comprising said peripheral wall of said depression tapering inwardly from said top wall of said support to said lower wall of said depression.

4. The device of claim 1, further comprising said top wall having a compartment extending therein configured for receiving a stirring device.

5. The device of claim 4, further comprising said compartment having a vertically-oriented longitudinal axis.

6. The device of claim 1, further comprising said retaining assembly being coupled to said peripheral wall of said depression.

7. The device of claim 6, further comprising said retaining assembly including a plurality of securing members being spaced from each other on said peripheral wall of said depression.

8. The device of claim 7, further comprising each of said securing members being comprised of a non-slip material.

9. The device of claim 8, further comprising each of said securing members being elongated.

10. The device of claim 9, further comprising each of said securing members extending from said top wall of said support to said lower wall of said depression.

11. The device of claim 1, further comprising said opening being one of a pair of said openings, said openings being spaced and horizontally aligned relative to each other, each of said openings being configured for receiving one of the user's feet.

12. The device of claim 1, further comprising said support including an upper section and a lower section integrally coupled together, said upper section including said top wall, said lower section having a top surface spaced below said top wall, said perimeter wall of said support including a medial wall coupled to and extending between said top wall and said top surface of said lower section.

13. The device of claim 12, further comprising said at least one opening extending into said lower section of said support.

14. The device of claim 1, further comprising said perimeter wall including a first end and a second end of said support, said depression being positioned proximate to said second end, each said opening extending into said first end of said support.

15. A mixing bucket holder device comprising:
a support having a top wall, a bottom wall and a perimeter wall coupled to and extending between said top wall and said bottom wall, said perimeter wall including a first end and a second end of said support, said top wall having a depression therein configured for receiving a mixing bucket, said depression being positioned proximate to said second end, said depression comprising a lower wall and a peripheral wall coupled to and extending upwardly from said lower wall, said lower wall being planar and horizontally orientated, said peripheral wall tapering inwardly from said top wall to said lower wall, said support including an upper section and a lower section integrally coupled together, said upper section including said top wall, said lower section having a top surface spaced below said top wall, said perimeter wall of said support including a medial wall coupled to and extending between said top wall and said top surface of said lower section;
said top wall having a plurality of compartments extending therein each configured for receiving a stirring device, each said compartment having a vertically-oriented longitudinal axis;
said lower section of said support having a pair of openings extending therein, said openings being spaced and horizontally aligned relative to each other, each of said openings being configured for receiving a foot of a user therein, each of said openings extending into said first end of said support, each said opening being directed inwardly into said support and towards said depression, each said opening having a depth extending into said support such that an entirety of each said opening is offset from said depression, a respective top of each said opening being coplanar with said lower wall;
a plurality of wheels coupled to said bottom wall of said support; and
a retaining assembly positioned on and attached to said peripheral wall of said depression, said retaining assembly being configured to engage the mixing bucket and maintain the mixing bucket in a stationary position while contents of the mixing bucket are being mixed together, said retaining assembly including a plurality of securing members being spaced from each other on said peripheral wall of said depression, each of said securing members being comprised of a non-slip material, each of said securing members being elongated, each of said securing members extending from said top wall of said support to said lower wall of said depression.
